(19) United States
(12) Patent Application Publication
(10) Pub. No.: US 2010/0024141 A1
(43) Pub. Date: Feb. 4, 2010

(54) Sponge For Holding Stimulation Device

(76) Inventors: Cheryl BERRY, St. Louis, MO (US); David CLAUS, Portland, OR (US); Joseph HANSEN, Portland, OR (US)

Correspondence Address: LATHROP & GAGE LLP, 2345 GRAND Boulevard, SUITE 2400, KANSAS CITY, MO, 64108, US

(21) Appl. No.: 12/502,756

(22) Filed: Jul. 14, 2009

Related U.S. Application Data
(60) Provisional application No. 61/080,498, filed on Jul. 14, 2008.
(60) Provisional application No. 61/089,371, filed on Aug. 15, 2008.

(51) Int. Cl. A47K 7/02; A61H 1/00; A46B 5/00

(52) U.S. Cl. 15/105; 15/244.4; 601/46; 15/145

(57) ABSTRACT

An apparatus for stimulation of the body, including sexual stimulation, includes a body, formed by a bathing or showing sponge, with a compartment for holding a stimulating apparatus, such as a vibrator. The compartment with the stimulating apparatus is concealed by the body, from plain view.

### CROSS REFERENCES TO RELATED APPLICATIONS

This application is related to and claims priority from commonly owned U.S. Provisional Patent Application Ser. No. 61/080,498, filed Jul. 14, 2008 and U.S. Provisional Patent Application Ser. No. 61/089,371, filed Aug. 15, 2008, the disclosures of which are incorporated by reference herein.

### TECHNICAL FIELD

The present disclosed subject matter relates to articles such as bath and shower sponges that are fitted with compartments for holding stimulation devices.

### BACKGROUND

Vibrators and other stimulating devices are available worldwide. These devices are used as sexual aids, as well as for pleasure, for example, in achieving sexual climax or orgasm, typically in human females. Moreover, these devices are in more widespread use today, due to their greater public acceptance. These devices are seeing further increased use, as sex therapists are prescribing them as part of treatment programs and the user can receive the benefits of sexual stimulation without the risk or fear of sexually transmitted diseases, from actual sexual contact from a human partner.

### SUMMARY

The present disclosed subject matter provides an apparatus or article that may be used while the user is showering or bathing (collectively, “bathing”), to provide stimulation to a desired part of the body, such as the genitalia for sexual stimulation. The apparatus is also usable outside of a bathing or showering environment.

The apparatus includes a body, formed by a bathing or showing sponge, with a compartment for holding a stimulating apparatus, such as a vibrator. The compartment with the stimulating apparatus is concealed from plain view by the body of the apparatus. As a result, the user can perform two functions contemporaneously, clean themselves as well as stimulate themselves. Moreover, the stimulation exercise is discrete, as it is performed in a shower or bath, and the device is hidden in the showering or bathing accessory, for example, a sponge, avoiding any potential social embarrassment.

An embodiment of the disclosed subject matter is directed to a bathing apparatus, used in bathing, showering and the like. The apparatus includes a main body and a compartment coupled with the main body. The compartment is configured for holding a stimulating apparatus, for example, a vibrator, and the compartment is at least partially covered by the main body.

### BRIEF DESCRIPTION OF THE DRAWINGS

Attention is now directed to the drawing figures, wherein like reference numerals or characters indicate corresponding or like components. In the drawings:

FIG. 1 is a perspective view of the apparatus in accordance with the disclosed subject matter;

FIG. 2 is a perspective view of an alternate compartment for the apparatus of FIG. 1;

FIG. 3 shows the apparatus of FIG. 1 in an exemplary operation;

FIG. 4 is a perspective view of an alternate apparatus in accordance with the disclosed subject matter; and,

FIG. 5 shows the apparatus of FIG. 4 in an exemplary operation.

### DETAILED DESCRIPTION OF THE DRAWINGS

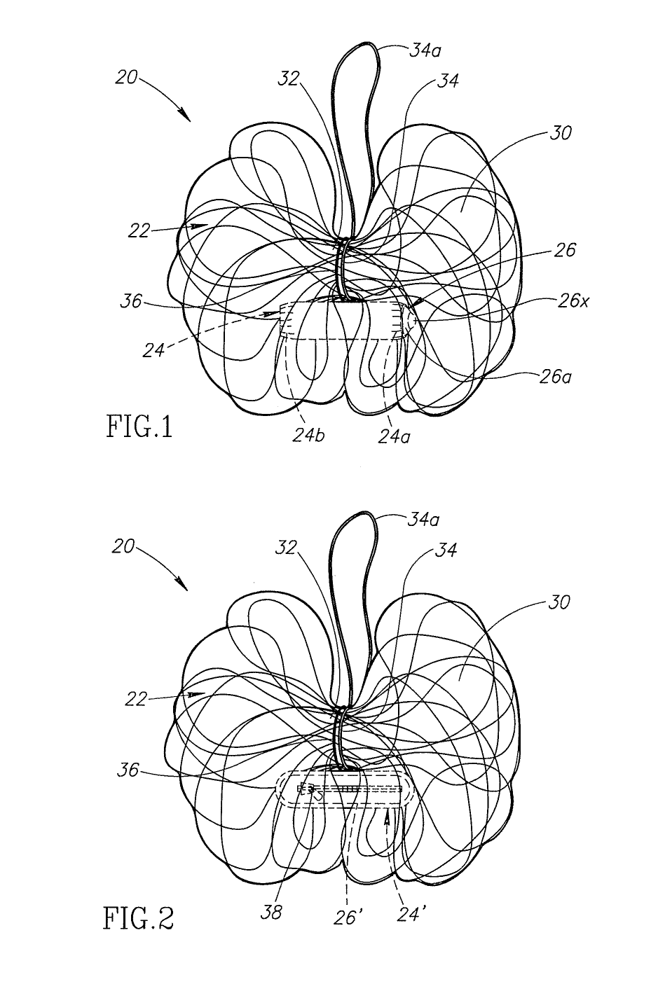

FIG. 1 shows the apparatus 20 of the disclosed subject matter. The apparatus 20 includes a body 22 that supports a compartment 24, shown, for example, as a pouch or pocket, that holds a stimulation device or stimulating apparatus 26, for example, a vibrator. The body 22, performs at least one of surrounding, covering or concealing the stimulating apparatus 26 (in the compartment 24) from the immediate or plain view of an individual.

The body 22, is, for example, in the form of a bathing or showering accessory, such as a sponge, for example, a mesh bath sponge 30, with mesh material 31. The mesh material 31 is gathered at a midsection 32, with the midsection 32 held in place by a string 34, that also forms a loop 34a, that can be held by the user or used in hanging the apparatus 20, when not in use (or prior or during use in a bathing/showering operation).

The compartment 24 includes a string 36, attached thereto, by stitching and/or other fasteners, with the string 36 tied around the midsection 32, to secure the compartment 24 to the body 22. The compartment 24 is, for example, of a mesh, polymeric or cloth material, so as to dry easily, and is of a thinness to allow for vibrations, motions and the like, produced by the stimulating apparatus 26 to pass therethrough, for stimulation.

The compartment 24 is elasticized at its ends 24a, 24b, so as to snugly retain the stimulating apparatus 26. As shown in FIG. 1, both ends 24a, 24b, are elasticized and open. However, for this embodiment, only one end 24a needs to be elasticized and open to accommodate the activation end 26a (the ON/OFF button 26x of the stimulating apparatus 26), that is exposed for access by the user (to activate and deactivate the stimulation device 26). The compartment 24 is such that the stimulating apparatus 26 can be easily removed therefrom and inserted therein.

The stimulating apparatus 26 is waterproof, water resistant, and/or watertight (collectively referred to hereinafter as waterproof). It is, for example, battery powered and may be, for example, a line of small vibrators known as “bullets”, or any other suitable vibrating apparatus or the like that fits in the compartment 24.

In alternate embodiments, the midsection 32 may be arranged so as to define a compartment into which the stimulating apparatus 26 may be placed and retained. Additionally, the body 22 may be formed by natural or synthetic sponges, loafah sponges or other materials or combinations thereof.

FIG. 2 shows an alternate compartment 24′ within the body 22 of the apparatus 20. This alternate compartment 24′ is designed to completely enclose the stimulating apparatus 26′, and is accessible by the user, for example, by a zipper 38 or other closure, to access the stimulation apparatus 26′ (similar to the stimulation apparatus 26 detailed above). The compartment 24′ is, for example of a waterproof material, but need not be. This stimulation device 26′ may be waterproof, like that detailed above, but does not need to be waterproof when the compartment 24′ is of a waterproof material. Similar to the compartment 24, the material for the compartment 24′ is of a thinness sufficient to allow for transmission of vibrations or other motions from the stimulating apparatus 26′ for stimulation.

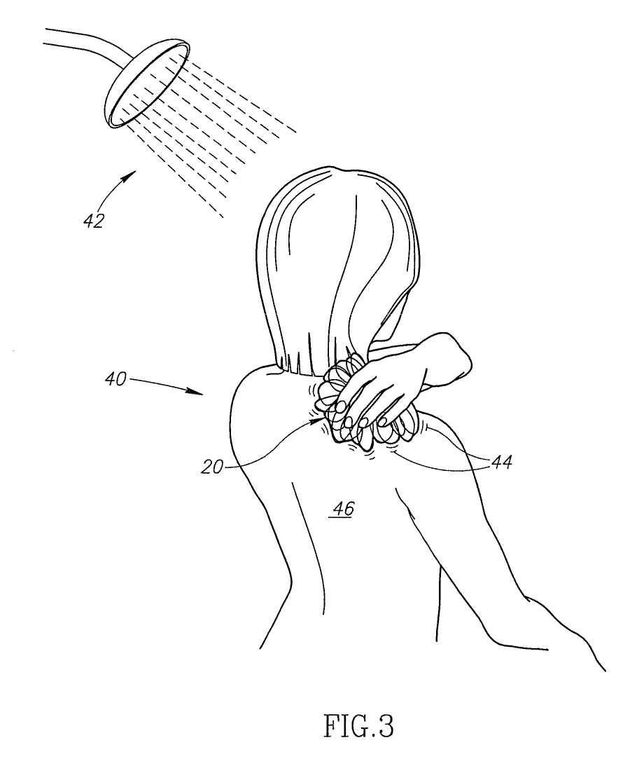

FIG. 3 shows the apparatus 20 being used by a user 40. Here, the user 40 is showering in a shower 42 and the stimulating apparatus 26 is activated or ON (as indicated by the circular lines 44). The user 40 places the apparatus 20 against or in proximity to the part of their body 46 (or the body of another person if multiple people are showering) where stimulation is desired. While use is in a shower 42 is shown, use in other areas such as bathrooms, bedrooms and the like is also permissible.

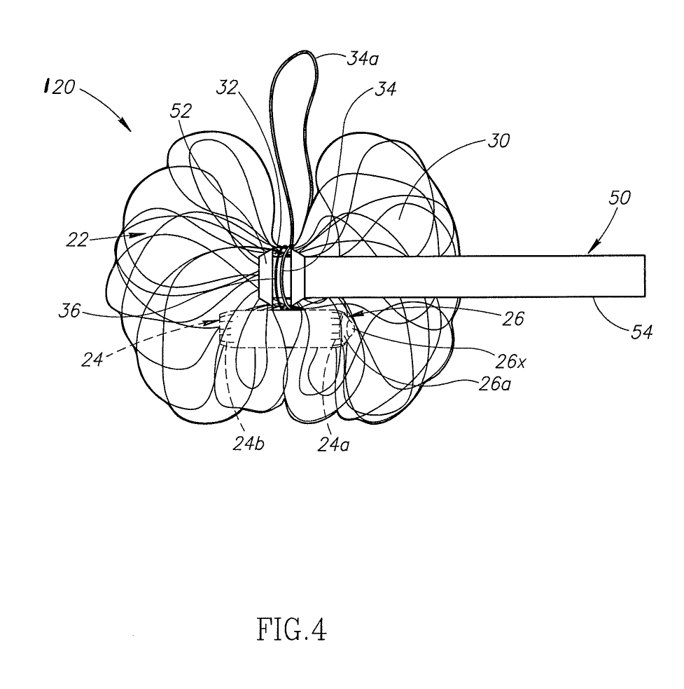

Attention is now directed to FIG. 4. The apparatus 120 is similar to apparatus 20 in all aspects of construction, in accordance with that described above and shown in FIGS. 1-3. Accordingly, similar structures are numbered similarly. The apparatus 120 is different from the apparatus 20, in that it includes a handle unit 50.

The handle unit 50 includes a cup 52 mounted in the midsection 32 (by being bound, tied, adhesively, or otherwise mechanically fastened thereto) that receives a handle 54. The handle 54 is, for example, removable from the cup 52, and may be fit into the cup 52 by a friction fit, screw threads or the like. Alternately the handle unit 50 may be a single member, permanently joined to the body 22 at the midsection 32.

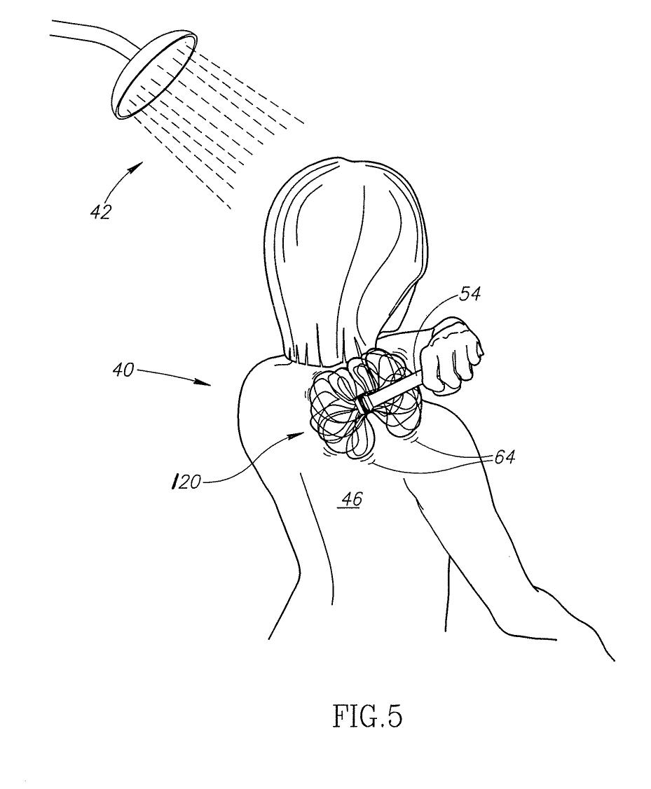

FIG. 5 shows the apparatus 120 being used by the user 40. The use is similar to that for apparatus 20, as shown in FIG. 3, except, the user 40 is holding the apparatus 120 and contacting her body 46, via the handle 54.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

What is claimed is:

1. A bathing apparatus comprising:
a main body; and,
a compartment in operative communication with the main body configured for holding a stimulating apparatus and at least partially covered by the main body.

2. The bathing apparatus of claim 1, additionally comprising: a stimulation apparatus.

3. The bathing apparatus of claim 2, wherein the stimulating apparatus includes a vibrator.

4. The bathing apparatus of claim 2, wherein the main body configured for at least partially covering the compartment, covers the compartment.

5. The bathing apparatus of claim 4, wherein the main body includes a sponge.

6. The bathing apparatus of claim 5, wherein the sponge includes a mesh sponge.

7. The bathing apparatus of claim 6, wherein the sponge is selected from the group consisting of: artificial sponges, natural sponges or combinations thereof.

8. The bathing apparatus of claim 1, additionally comprising: a handle unit in communication with the main body.

9. The bathing apparatus of claim 8, wherein the handle unit includes a detachable handle.
